(19) United States
(12) Patent Application Publication
(10) Pub. No.: US 2017/0321727 A1
(43) Pub. Date: Nov. 9, 2017

(54) HYDRAULIC CIRCUIT COMPRISING A VERY-LOW-PRESURE RESERVOIR PLACED UNDER NEGATIVE PRESSURE

(71) Applicant: TECHNOBOOST, Paris (FR)

(72) Inventors: Arnaud Le Dren, Brunoy (FR); Andres Yarce, Nanterre (FR); Stephane Maurel, Issy Les Moulineaux (FR)

(21) Appl. No.: 15/533,587

(22) PCT Filed: Nov. 19, 2015
(86) PCT No.: PCT/FR2015/053130

§ 371 Date: Jun. 6, 2017

(30) Foreign Application Priority Data
Dec. 17, 2014 (FR) 1462639

(51) Int. Cl. F15B 1/26; F16H 61/4131; B60K 6/12; F15B 21/04

(52) U.S. Cl. CPC F15B 1/265; F15B 21/044; F16H 61/4131; B60K 6/12; F15B 2211/89; F15B 2211/613

(57) ABSTRACT

Hydraulic circuit comprising a low-pressure circuit (6) fed by a booster pump (4) that draws from a very-low-pressure reservoir (2), characterized in that this very-low-pressure reservoir (2) is leaktight and has a device for placing the internal volume (12) under negative pressure with respect to atmospheric pressure.

### CROSS-REFERENCE TO RELATED APPLICATIONS

This application is the U.S. National Stage under 35 U.S.C. §371 of International App. No. PCT/FR2015/053130 filed on Nov. 19, 2015, and which claims priority to French App. No. 1462639 filed on Dec. 17, 2014, both of which are incorporated herein by reference.

### BACKGROUND

The present invention relates to a hydraulic circuit comprising a very low pressure reservoir for storing fluid, as well as a hybrid motor vehicle equipped with such a hydraulic circuit.

A known type of hybrid vehicle, shown in particular in FR3004999, comprises a hydraulic circuit comprising a first hydraulic machine receiving fluid from a low-pressure circuit, equipped with a low-pressure accumulator for generating a high pressure discharged into a high pressure accumulator in order to store hydraulic energy.

The high pressure supplies a second hydraulic machine working as a motor, the fluid then returning to the low pressure circuit.

In general, this type of hydraulic circuit comprising a low pressure circuit, used in industry or for traction of hydraulic hybrid motor vehicles, comprises a feeding device which draws from a very low pressure reservoir, generally at atmospheric pressure, receiving different leakage returns, for supplying the low pressure circuit with a minimum pressure, in order to avoid cavitation of the fluid, in particular at significant flow rates in the first hydraulic machine.

Indeed, cavitation of hydraulic machines poses problems of noise and damage to internal components.

The feeding pumps may be powered in a known manner by different means, comprising in particular an electric motor, or a hydraulic machine powered by a pressure from the hydraulic circuit.

The very low pressure reservoirs can be at atmospheric pressure, featuring an opening to the outside. With this type of reservoirs at atmospheric pressure, it is easier to extract gases dissolved in the fluid, as well as to purge the circuit.

However these reservoirs can cause problems of contamination of the internal fluid by the intake ports, in particular from external particles, moisture, or oxygen in the air, causing an oxidation of this fluid. These different contaminants accelerate the aging of the fluid by degrading its qualities, which can damage the hydraulic circuit.

It is also known to seal the very low pressure reservoirs, in order to apply to them a slight pressurization with respect to atmospheric pressure, in order to protect the fluid contained therein by avoiding an entry of external elements.

Nevertheless, this slight pressurization does not favor the extraction of the gases dissolved in the fluid, and it is possible to have problems in purging the hydraulic circuit.

### SUMMARY

The object is thus to provide a hydraulic circuit which will, in particular, avoid these disadvantages of the prior art.

To this end, a hydraulic circuit is disclosed which comprises a low pressure circuit supplied by a feeding pump which draws from a very low pressure reservoir defining an internal volume, noteworthy in that this very low pressure reservoir is sealed and comprises a device for depressurizing the internal volume with respect to atmospheric pressure.

An advantage of this hydraulic circuit is that, in a simple and effective manner, by providing a sealed reservoir in which the depressurization device maintains a very low pressure, which is lower than atmospheric pressure, a fluid reserve is arranged for the feeding pump in which the gases dissolved in the fluid can easily be extracted by virtue of the reduced pressure of this fluid.

The hydraulic circuit according to the invention can additionally comprise one or more of the following characteristics which can be combined with one another.

According to one embodiment, the device for depressurizing the internal volume comprises a vacuum pump.

According to another embodiment, the device for depressurizing the internal volume comprises a check valve connected to atmospheric pressure, allowing only an outward passage.

Advantageously, the check valve comprises a calibration spring.

Advantageously, the sealed reservoir initially comprises nitrogen, replacing the air.

Also disclosed is a hybrid motor vehicle comprising a hydraulic circuit used for the traction of this vehicle, which comprises any of the preceding features.

In this case, since the vehicle is equipped with an internal combustion engine, in which case, the device for depressurizing the internal volume may include a vacuum pump, which is driven by this internal combustion engine.

Alternatively, in the vehicle being equipped with an internal combustion engine comprising an intake manifold, the device for depressurizing the internal volume may comprise a vacuum connection on this intake manifold.

### DESCRIPTION OF THE FIGURES

The invention will be better understood and other features and advantages will appear more clearly upon reading the description given hereinafter, by way of example and in a non-limiting manner, with reference to the accompanying drawings in which:

FIG. 1 is a diagram of a hydraulic circuit comprising first means of depressurizing; and

FIGS. 2a, 2b and 2c are diagrams of a hydraulic circuit according to a variant, comprising a second means of depressurizing, presented in three successive actual situations.

### DETAILED DESCRIPTION

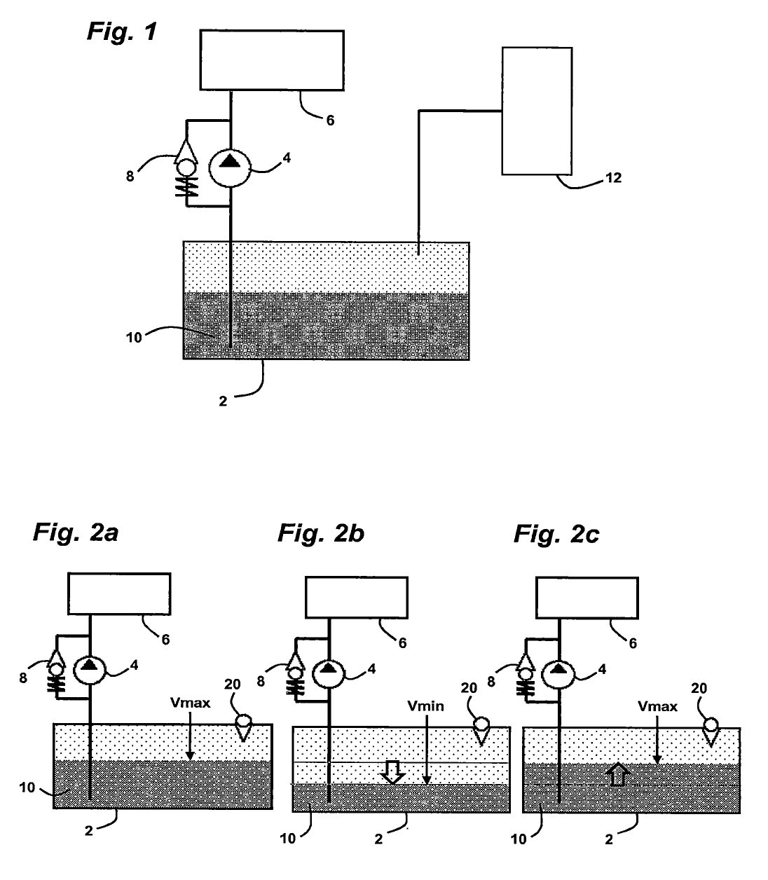

FIG. 1 shows a hydraulic circuit comprising a sealed reservoir 2 containing a fluid 10 drawn by a feeding pump 4 to supply a low pressure circuit 6 at a minimum pressure. The sealed reservoir 2 comprises orifices (not shown), which are usually arranged for maintenance operations, such as a filling and drain opening, which are closed during operation.

The feeding pump 4, which can be powered by various means, such as an electric motor or a hydraulic machine, comprises a calibrated check valve 8 arranged in parallel with the feeding pump 4, enabling the fluid to pass from downstream to the upstream, in order to limit its outlet pressure to the required pressure in the low pressure circuit 6.

The hydraulic circuit comprises a pressure source 12 connected to the sealed reservoir 2, which generates a pressure lower than atmospheric pressure in order to maintain this reservoir under reduced pressure.

For a hydraulic circuit used in a hybrid motor vehicle, the pressure source commonly disposed in vehicles can be used in particular to power the vacuum braking assistance system. The pressure source may in particular be a vacuum port on the intake manifold for a vehicle equipped with an internal combustion engine, or a pressure pump driven by this internal combustion engine, or by an independent electric motor.

It will be noted that in this case the sealed reservoir 2, which must be sufficiently rigid to withstand the external atmospheric pressure, constitutes an additional vacuum reserve connected to the braking assistance system, which gives greater autonomy to this assistance in the event of stopping the operation of the pressure source. Better safety for the braking system is this provided.

The sealed reservoir 2, which does not have outward communication during operation, is thus protected from direct exchanges with the external environment, and thus avoids intrusions from the ambient environment, in particular particles of dust, moisture or oxygen from the air.

It is thus easier to preserve the quality of the fluid contained in the reservoir, which is favorable for the aging of this fluid, and the endurance of the various components of the hydraulic circuit. In particular, preservation of the filtration system of this hydraulic circuit, which can be renewed less frequently, is ensured.

Moreover, the pressure system 12 frequently or permanently aspirates the gases in the sealed reservoir 2, at the same time removing the gases dissolved in the fluid, in particular air, which also facilitates the purging of the hydraulic circuit.

It will be noted that the feeding pump 4, implementing pumping in the slightly depressurized fluid 10, constitutes a type of pump delivering a low pressure with a low flow rate which is generally self-priming, with a low sensitivity to cavitation.

FIGS. 2a, 2b and 2c present a sealed reservoir 2 equipped in the upper part with a check valve 20 allowing only an outward passage, which is connected to atmospheric pressure.

In particular, the valve 20 may comprise a calibration spring ensuring a small threshold of negative pressure in the reservoir 2 before it is opened.

In this way, it ensures a better sealing of this valve 20, which can only open with a pressure threshold. In addition, the reduced pressure in the reservoir 2 is reduced by a value equal to the deviation given by the calibration spring, which simplifies the manufacturing of the reservoir subjected to a lower pressure difference.

The operation of the check valve 20 forming a depressurizing device of the reservoir 2 is as follows.

During the operation of the complete hydraulic circuit, there are variations in the overall fluid volume in this circuit, including in particular the variations in filling of the various pressure accumulators, as well as deviations due to the expansion of the fluid and the components, which translate to a resulting variation in the level of the reservoir 2.

Starting from an actual situation in which the volume of the fluid in the reservoir 2 is at a maximum with an internal pressure equal to the atmospheric pressure, giving a maximum level Vmax shown in FIG. 2a, during the following operation there are decreases in the level in this reservoir, which can reach the minimum level Vmin shown in FIG. 2b.

During this phase of reduction of the volume of fluid, there is then a lack of external air intake due to the check valve 20 remaining blocked, consequently generating a negative pressure in the reservoir 2, which is in proportion to the ratio of the free volume remaining in this reservoir, with the maximum level Vmax, on the free volume remaining with the minimum level Vmin.

Subsequently, when the volume of fluid in the reservoir 2 is increased, the pressure in this reservoir will also rise, while remaining less than the atmospheric pressure, which keeps the check valve 20 closed, in order to theoretically reach this atmospheric pressure, if the level returns to the maximum level Vmax as shown in FIG. 3a. In the event that this atmospheric pressure is exceeded, then gas escapes from the check valve 20.

It is possible in practice to have small deviations, due in particular to variations in the temperature of the fluid causing a different expansion of this fluid and the components, however the check valve 20 operating as a vacuum pump will in all cases maintain an internal pressure of the reservoir, which is less than or equal to atmospheric pressure.

In the same way, an optimal degassing of the fluid with the pressure is obtained.

In addition to the two versions of the depressurizing device, it is possible to initially fill the closed reservoir 2 with nitrogen to replace the air, thus avoiding oxidation of the fluid.

1. A hydraulic circuit comprising a low-pressure circuit powered by a feed pump drawing from a very low pressure reservoir, wherein the very low pressure reservoir is sealed for depressurizing an internal volume of the very low pressure reservoir with respect to atmospheric pressure.

2. The hydraulic circuit according to claim 1, wherein the depressurizing device of the internal volume comprises a vacuum pump.

3. The hydraulic circuit according to claim 1, wherein the depressurizing device of the internal volume comprises a check valve connected to atmospheric pressure, allowing only an outward passage.

4. The hydraulic circuit according to claim 3, wherein the check valve comprises a calibration spring.

5. The hydraulic circuit according to claim 1, wherein the sealed reservoir initially comprises nitrogen, replacing the air.

6. A hybrid motor vehicle comprising the hydraulic circuit of claim 1, wherein the hydraulic circuit is used for the traction of this vehicle.

7. The hybrid motor vehicle according to claim 6, wherein the vehicle is equipped with an internal combustion engine, and wherein the depressurizing device of the internal volume comprises a vacuum pump which is powered by the internal combustion engine.

8. The hybrid motor vehicle according to claim 6, wherein the vehicle internal combustion engine comprises an intake manifold, the depressurizing device of the internal volume comprising a vacuum port on the intake manifold.
